(19) United States
(12) Patent Application Publication
(10) Pub. No.: US 2013/0068839 A1
(43) Pub. Date: Mar. 21, 2013

(54) METHOD OF AND APPARATUS FOR IMAGING TARGETS BY UTILIZING MULTIPLE IMAGING MODULES WITH ON-BOARD LOCAL MICROPROCESSORS

(71) Applicants: Mark DRZYMALA, Commack, NY (US); Edward Barkan, Miller Place, NY (US); Bradley Carlson, Doylestown, PA (US); Robert Pang, Williston Park, NY (US)

(72) Inventors: Mark DRZYMALA, Commack, NY (US); Edward Barkan, Miller Place, NY (US); Bradley Carlson, Doylestown, PA (US); Robert Pang, Williston Park, NY (US)

(73) Assignee: Symbol Technologies, Inc., Holtsville, NY (US)

(21) Appl. No.: 13/238,353

(22) Filed: Sep. 21, 2011

(51) Int. Cl. G06K 7/14

(52) U.S. Cl. 235/454

(57) ABSTRACT

An apparatus for, and method of, imaging a target presented to a bi-optical, dual window, point-of-transaction workstation utilizes multiple imaging modules individually mounted for individual installation on, and individual removal from, a motherboard. Each module includes a solid-state imager having an array of light-sensitive sensors for capturing return light from the target over a field of view; a local controller externally of the imager for controlling the imager, for storing image data corresponding to the captured return light, and for interrogating the stored image data; and a daughterboard on which the imager and the local controller are both commonly mounted.

### FIELD OF THE DISCLOSURE

The present disclosure relates generally to an apparatus for, and a method of, imaging targets and, more particularly, to utilizing multiple imaging modules, each having an on-board local microprocessor, to perform such imaging.

### BACKGROUND

It is known to use laser-based and/or imager-based readers or scanners in a dual window or bi-optical workstation to electro-optically read targets, such as bar code symbols, associated with three-dimensional products to be identified and processed, e.g., purchased, at a point-of-transaction workstation provided at a countertop of a checkout stand in supermarkets, warehouse clubs, department stores, and other kinds of retailers. The products are typically slid or moved in various directions by a user across, or presented to a central region of, a generally horizontal window that faces upwardly above the countertop and/or a generally vertical or upright window that rises above the countertop. When at least one laser scan line generated by a laser-based reader sweeps over a symbol target and/or when return light from a symbol target is captured over a field of view by a solid-state imager of an imager-based reader, the symbol target is then processed, decoded and read, thereby identifying the product.

The symbol target may be located low or high, or right to left, on the product, or anywhere in between, on any of six sides of the product. The symbol target may be oriented in a “picket fence” orientation in which elongated parallel bars of a one-dimensional Universal Product Code (UPC) symbol are vertical, or in a “ladder” orientation in which the UPC symbol bars are horizontal, or at any orientation angle in between. The products may be held by the user at various tilt angles during their movement across, or presentation to, either window. The products may be moved relative to the windows in various directions, for example, from right-to-left, or left-to-right, and/or in-and-out, or out-and-in, and/or high-to low, or low-to-high, or any combination of such directions, or may be positioned either in contact with, or held at a working distance in a working distance range away from, either window during such movement or presentation. All these factors make the target symbol location variable and difficult to predict in advance. In such an environment, it is important that the laser scan lines of the laser-based reader, or the field of view of the imager-based reader, that pass through either window provide a full coverage scan zone which extends down as close as possible to the countertop, and as high as possible above the countertop, and as wide as possible across the width of the countertop.

As advantageous as workstations with the laser-based readers have been in processing transactions, workstations with the imager-based readers are thought to offer improved reliability and have the added capability of reading symbol targets other than UPC symbols, such as two-dimensional or stacked or truncated symbols, as well as the capability of imaging non-symbol targets, such as receipts, driver's licenses, signatures, etc. It was initially thought that an all imager-based workstation would require about ten to twelve imagers in order to read a target that could be positioned anywhere in the scan zone and on any of all six sides of a product. To be successful in the marketplace, however, an all imager-based workstation must eliminate the need for so many imagers to bring the cost of all the imagers, as well as the cost of the entire workstation, down to an acceptable level, for example, six or less. The all imager-based workstation must also match, or at least be comparable to, the working distance range, processing speed, productivity and performance of a laser-based workstation. In the case of a bi-optical workstation having dual windows, the all imager-based workstation must use similar window sizes and must also be able to scan anywhere across the windows and over a comparable working distance range as that of a laser-based workstation, so that users can achieve the high scanning productivity they have come to expect without any need to learn a new scanning technique.

Each imager, also known as a camera or image sensor, is advantageously a charge coupled device (CCD) or a complementary metal oxide semiconductor (CMOS) device, and includes a one- or two-dimensional array of photosensitive cells or photosensors that correspond to image elements or pixels in the field of view of the imager, and typically has an associated illumination assembly to illuminate the target with illumination light from one or more illumination light sources, e.g., light emitting diodes (LEDs). A single master programmed microprocessor or controller is operative for controlling each illumination assembly to illuminate the target, for controlling each imager to capture the illumination light returning from the target over an exposure time period to produce electrical signals indicative of the target being imaged, and for processing the electrical signals to read the target. Each imager detects the return illumination light reflected and/or scattered from the target and preferably operates at a frame rate of multiple frames per second, e.g., sixty frames per second, each frame lasting about 16.67 milliseconds.

The imagers, the illumination light sources and the master controller are commonly assembled on a main printed circuit board (PCB) or motherboard to enable joint installation of the entire PCB assembly at, and joint removal of the entire PCB assembly from, the workstation for ease of serviceability and to simplify field maintenance. Yet, the joint installation and removal of the entire PCB assembly can be an expensive maintenance and manufacturing proposition. If only one imager malfunctions in the field, then the entire PCB assembly may have to be replaced. During manufacture, each imager typically includes a focusing lens that has to be optically adjusted to focus a target on the respective imager. It can be difficult to adjust multiple imagers, all on the same motherboard. If dust occurs on only one of the focusing lenses and/or on only one of the imagers, typically as a byproduct of such adjustment, then the entire PCB assembly may have to be removed to clean the dusty lens and/or imager, or replaced with a clean PCB assembly.

In addition, the single master controller that, as noted above, is tasked not only with controlling all the imagers and the illumination light sources, but also with interrogating and decoding the captured images from all the multiple imagers within frames each lasting about 16.67 milliseconds, must advantageously be a powerful, robust processor to achieve the fast processing speed and quick performance already provided by the known laser-based workstations. Thus, it has proven to be somewhat costly to equip an imager-based workstation with a single master controller. Also, if the single master controller malfunctions in the field, then the entire PCB assembly will have to be replaced, again increasing maintenance and downtime costs.

Accordingly, there is a need for an apparatus for, and a method of, imaging targets in an imager-based workstation that does not employ a single master controller to control multiple imagers.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a dual window, bi-optical, point-of-transaction workstation or apparatus operative for imaging and reading targets;

FIG. 2 is a part-sectional, part-diagrammatic, schematic view of a workstation analogous to that shown in FIG. 1;

FIG. 3 is a perspective view of a dual window, bi-optical, point-of-transaction workstation or apparatus operative for imaging and reading targets using a trio of imagers;

FIG. 4 is a view similar to FIG. 3 of another embodiment using six imagers;

FIG. 5 is a bottom perspective view of a dual window, bi-optical, point-of-transaction workstation or apparatus analogous to the embodiment of FIG. 4, as seen from below with a lower protective cover removed, using six imaging modules, in accordance with this invention; and

FIG. 6 is a bottom, exploded, perspective view depicting the assembly of the six imaging modules of FIG. 5 on a motherboard in accordance with this invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One feature of this invention resides, briefly stated, in a workstation for imaging a target by electro-optically reading target indicia. The workstation includes a housing, a motherboard or main printed circuit board (PCB) supported by the housing, and a plurality of imaging modules individually mounted for individual installation on, and individual removal from, the motherboard. Each module includes a solid-state imager having an array of light-sensitive sensors for capturing return light from the target over a field of view; a local controller or microprocessor externally of the imager for controlling the imager, for storing image data corresponding to the captured return light, and for interrogating the stored image data; and a daughterboard or auxiliary PCB on which the imager and the local controller are both commonly mounted.

The use of a plurality of local controllers, rather than a single master controller as taught by the prior art, enables each local controller to be less costly, less powerful, and less robust than the single master controller of the prior art, without sacrificing fast processing speed and quick workstation performance. This individual installation of each module at, and individual removal of each module from, the motherboard ensures, among other things, that the entire motherboard need not have to be replaced if only one of the imagers or only one of the local controllers malfunctions or fails. Maintenance and downtime costs are minimized. In addition, it is easier to adjust the focusing lens of individual imagers, each on its own daughterboard, during manufacture, rather than adjust multiple imagers all mounted on the same motherboard, and it is easier to clean dust off of individual focusing lenses and/or individual imagers, each on its own daughterboard, then off of multiple focusing lenses and/or multiple imagers, all mounted on the same motherboard.

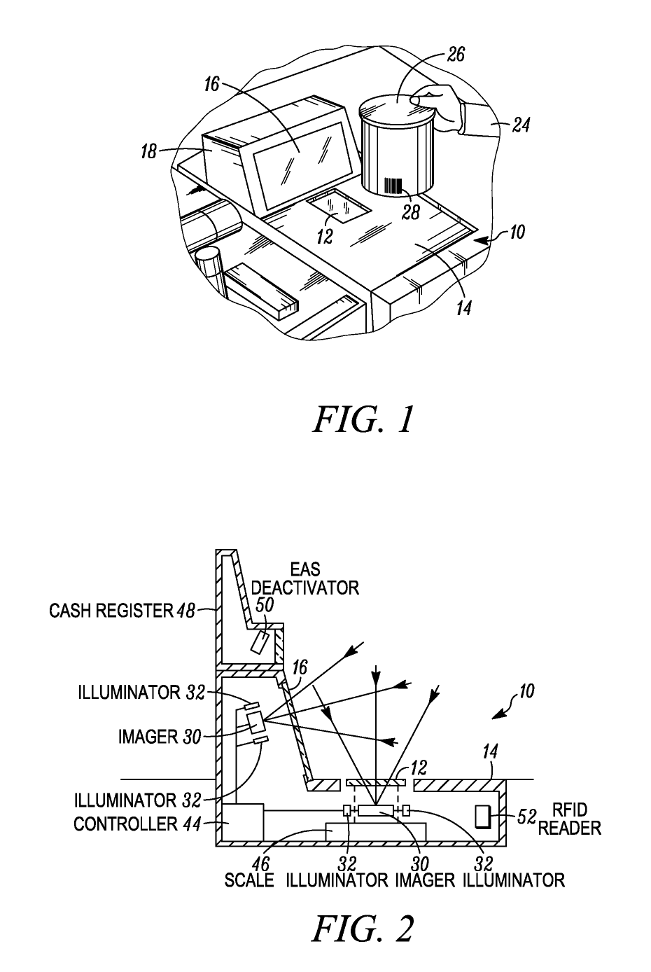

FIG. 1 depicts a dual window, bi-optical, point-of-transaction workstation 10 used by retailers to process transactions involving the purchase of products bearing an identifying target, such as the UPC symbol described above. Workstation 10 has a top wall 14 bounding a generally horizontal window 12 set flush with, or recessed into, a countertop, and a vertical or generally vertical (referred to as “vertical” or “upright” hereinafter) window 16 set flush with, or recessed into, a raised housing portion 18 above the countertop.

As schematically shown in FIG. 2, a plurality of solid-state imagers 30, each including or associated with one or more illumination light assemblies or illuminators 32, are also mounted at the workstation 10, for capturing light passing through either or both windows from a target, which can be a one- or two-dimensional symbol, such as a two-dimensional symbol on a driver's license, or any non-symbol target, such as a document, as described below. Each imager 30 is a solid-state array, preferably a one- or two-dimensional, charge coupled device (CCD) of the type generally found in consumer cameras. Each illuminator 32 is preferably one or more illumination light sources, e.g., surface-mounted, light emitting diodes (LEDs), preferably located at each imager 30 to uniformly illuminate the target, as further described below.

In use, an operator 24, such as a person working at a supermarket checkout counter or a consumer purchasing a product 26, processes the product 26 bearing a target such as a UPC symbol 28 thereon, past the windows 12, 16 by swiping the product across a respective window in the abovementioned swipe mode, or by presenting the product at the respective window in the abovementioned presentation mode. The symbol 28 may located on any of the top, bottom, right, left, front and rear, sides of the product, and at least one, if not more, of the imagers 30 will capture the illumination light reflected, scattered, or otherwise returning from the symbol through one or both windows. The imagers are preferably looking through the windows at around 45° so that they can each see a side of the product that is generally perpendicular to, as well as generally parallel to, a respective window.

FIG. 2 also schematically depicts that a weighing scale 46, a cash register 48, and an electronic article surveillance (EAS) deactivator 50 are mounted at the workstation. The generally horizontal window 12 advantageously serves not only as a weighing platter for supporting a product to be weighed, but also allows the return light to pass therethrough. The register 48 can sit atop the raised housing portion 18, or be integrated therewith. A radio frequency identification (RFID) reader 52 is also advantageously mounted at the workstation. The reader 52 can be mounted at any location and not only below the countertop, as shown.

As also schematically shown in FIG. 2, the imagers 30 and their associated illuminators 32 are operatively connected to a single master programmed microprocessor or controller 44 operative for controlling the operation of these and other components. Preferably, the microprocessor is the same as the one used for decoding the return light scattered from the target and for interrogating and processing the captured target images.

In operation, the microprocessor 44 sends successive command signals to the illuminators 32 to pulse the LEDs for a short time period of 100 microseconds or less, and successively energizes the imagers 30 to collect light from a target only during said time period, also known as the exposure time period. By acquiring a target image during this brief time period, the image of the target is not excessively blurred even in the presence of relative motion between the imagers and the target. Each imager preferably operates at a frame rate of multiple frames per second, e.g., sixty frames per second, each frame lasting about 16.67 milliseconds.

There are several different types of targets that have particular utility for the enhancement of the operation of the workstation. The target may be a personal check, a credit card, or a debit card presented by a customer for payment of the products being purchased. The operator need only swipe or present these payment targets at one of the windows for image capture. The target may also be a signature, a driver's license, or the consumer himself or herself. Capturing an image of the driver's license is particularly useful since many licenses are encoded with two-dimensional indicia bearing age information, which is useful in validating a customer's age and the customer's ability to purchase age-related products, such as alcoholic beverages or tobacco products. The target may be the operator himself or herself, which is used for video surveillance for security purposes. Thus, it can be determined if the operator is actually scanning the products, or passing them around the window in an effort to bypass the window and not charge the customer in a criminal practice known in retailing as “sweethearting.”

In addition to one-dimensional symbols, the target may be a two-dimensional symbol whose use is becoming more widespread, especially in manufacturing environments and in package delivery. Sometimes, the target includes various lengths of truncated symbols of the type frequently found on frequent shopper cards, coupons, loyalty cards, in which case the area imagers can read these additional symbols.

The energization of the imagers 30 can be manual and initiated by the operator. For example, the operator can depress a button, or a foot pedal, at the workstation. The energization can also be automatic such that the imagers operate in a continuous image acquisition mode, which is the desired mode for video surveillance of the operator, as well as for decoding two-dimensional symbols. In the preferred embodiment, all the imagers will be continuously sequentially energized for scanning symbols until such time as there has been a period of inactivity that exceeds a pre-program time interval. For example, if no symbols have been scanned for ten minutes, then after this time period has elapsed, the workstation enters a power-savings mode in which one or more of the imagers will be omitted from sequential energization. Alternatively, illumination levels may be reduced or turned off. At least one imager will remain active for periodically capturing images. If the active imager detects anything changing within its field of view, this will indicate to the operator that a product bearing a symbol is moving into the field of view, and illumination and image capture will resume to provide high performance scanning.

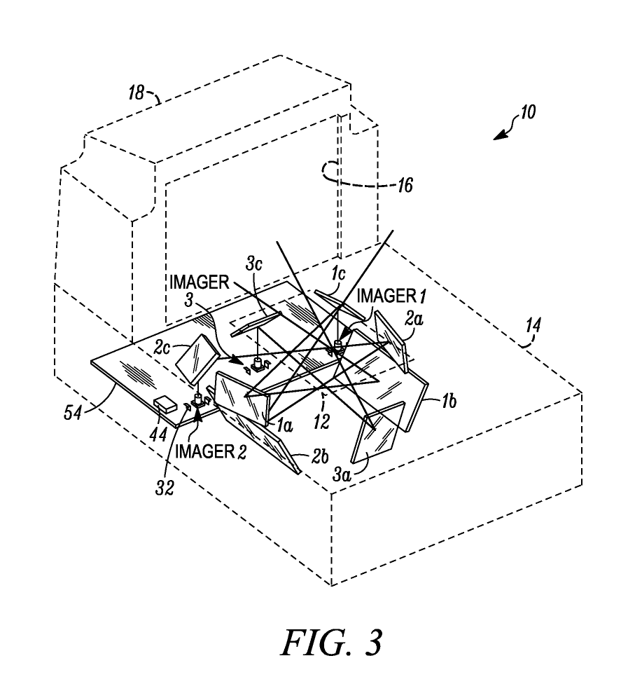

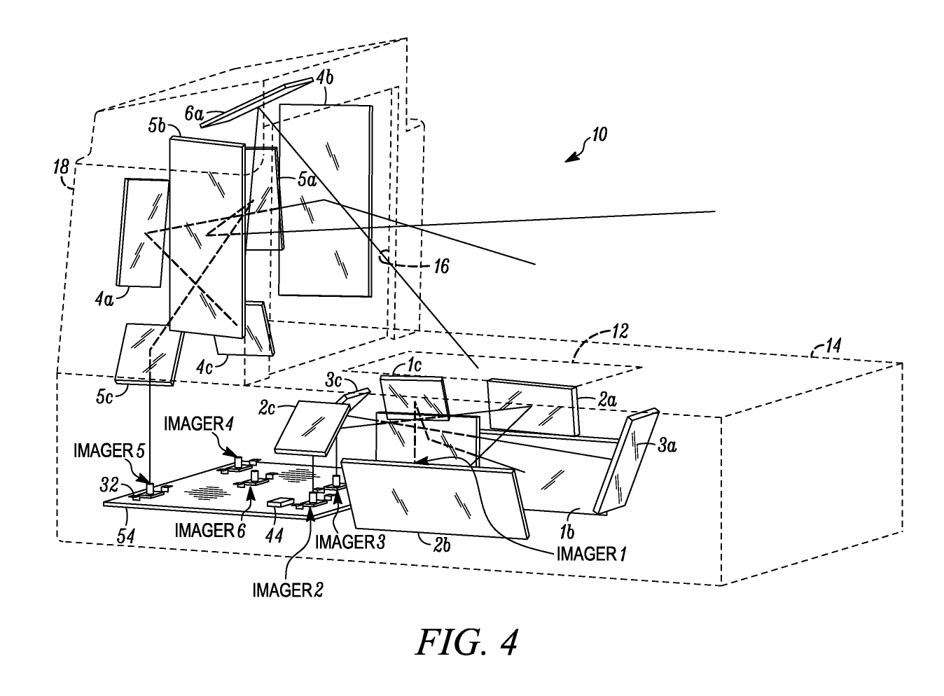

As previously stated, FIG. 2 is only a schematic representation of an all imager-based bi-optical workstation. Other workstations with housings having different shapes, with one or more windows, are also contemplated. A practical depiction of a bi-optical workstation is shown in FIGS. 3-4, in which all the imagers, now relabeled 1, 2, 3, 4, 5 and 6, and their illuminators 32, as well as the master controller 44, and other electrical components, as described below, are mounted on a main printed circuit board (PCB) or motherboard 54.

As shown in FIG. 3, the motherboard 54 lies in a generally horizontal plane generally parallel to, and below, the generally horizontal window 12, and imager 1 faces generally vertically upward toward an inclined folding mirror 1c directly overhead at a right side of the window 12. The folding minor 1c faces another inclined narrow folding minor 1a located at a left side of the window 12. The folding minor 1a faces still another inclined wide folding mirror 1b adjacent the mirror 1c. The folding mirror 1b faces out through the generally horizontal window 12 toward the left side of the workstation.

Imager 2 and its associated optics is minor symmetrical to imager 1 and its associated optics. Imager 2 faces generally vertically upward toward an inclined folding mirror 2c directly overhead at the left side of the window 12. The folding mirror 2c faces another inclined narrow folding mirror 2a located at the right side of the window 12. The folding minor 2a faces still another inclined wide folding mirror 2b adjacent the minor 2c. The folding mirror 2b faces out through the generally horizontal window 12 toward the right side of the workstation.

Imager 3 and its associated optics are located generally centrally between imagers 1 and 2 and their associated optics. Imager 3 faces generally vertically upward toward an inclined folding minor 3c directly overhead generally centrally of the window 12 at one end thereof. The folding minor 3c faces another inclined folding minor 3a located at the opposite end of the window 12. The folding minor 3a faces out through the window 12 in an upward direction toward the raised housing portion 18.

As described so far, a trio of imagers 1, 2 and 3 capture light along different, intersecting fields of view along different directions through the generally horizontal window 12. Turning now to FIG. 4, an additional trio of imagers 4, 5 and 6 capture light along different, intersecting fields of view along different directions through the generally vertical window 16.

More particularly, imager 4 faces generally vertically upward toward an inclined folding mirror 4c directly overhead at a right side of the window 16. The folding mirror 4c faces another inclined narrow folding minor 4a located at a left side of the window 16. The folding mirror 4a faces still another inclined wide folding mirror 4b adjacent the minor 4c. The folding minor 4b faces out through the generally vertical window 16 toward the left side of the workstation.

Imager 5 and its associated optics is minor symmetrical to imager 4 and its associated optics. Imager 5 faces generally vertically upward toward an inclined folding mirror 5c directly overhead at the left side of the window 16. The folding mirror 5c faces another inclined narrow folding mirror 5a located at the right side of the window 16. The folding minor 5a faces still another inclined wide folding mirror 5b adjacent the minor 5c. The folding mirror 5b faces out through the generally vertical window 16 toward the right side of the workstation.

Imager 6 and its associated optics are located generally centrally between imagers 4 and 5 and their associated optics. Imager 6 faces generally vertically upward toward an inclined folding minor 6a directly overhead generally centrally of the window 16 at an upper end thereof. The folding minor 6a faces out through the window 16 in a downward direction toward the countertop.

In a conventional laser-based bi-optical workstation, the generally horizontal window measures about four inches in width by about six inches in length, and the generally vertical window measures about six inches in width by about ten inches in length. These large windows are filled with scan lines that project out several inches from the window, enabling targets or indicia to be scanned anywhere within a large volume. The all imager-based bi-optical workstation described herein preferably uses similar window sizes and must also be able to scan anywhere across the windows and over a comparable working distance range as a laser-based workstation. The field of view of an imager capturing illumination light through a respective window does not inherently have these dimensions at the respective window and, hence, the field of view must be modified so that it matches the dimensions of the respective window at the respective window, thereby enabling targets to be reliably read when located anywhere at the respective window, as well as within a range of working distances therefrom.

To achieve these goals, the optical path length from each imager to a respective window is maximized to enable filling the windows with their combined fields of view, while still allowing a narrow divergence angle of each field of view. This narrow divergence angle extends the range over which adequate pixel resolution is maintained. The folding minors 1a,1b,1c; 2a,2b,2c; 3a,3c; 4a,4b,4c; 5a,5b,5c; and 6a are used to fit the long optical path within the limited depth and other housing dimensions that are typical of bi-optical workstations. An adequately small divergence angle can be achieved with an optical path length of around eighteen to twenty inches. Shorter optical path lengths can be used, but the working distance range of adequate resolution will be reduced since a wider divergence angle will be needed to create an adequately sized field of view. Alternatively, a narrower divergence angle can be used with a shorter optical path, but the size of the field of view at the respective window will be reduced, which makes the reader more difficult to use. This may be satisfactory for less demanding scanning applications.

In the preferred embodiment, as noted above, each imager has an associated set of LEDs 32 that illuminate the target. The LED illumination systems include lenses (not shown) that concentrate the LED illumination light of each illuminator into a solid angle that approximately matches the field of view of each imager. The illumination for each imager is reflected off of the same folding mirrors as the field of view of its associated imager.

In many locations, the target can be seen by more than one imager. For example, a target located flat against the horizontal window 12 can be seen by both imager 1 and imager 2. These two imagers look at the target from different angles, and their associated illuminators 32 illuminate the target from different angles. As a result, a glossy indicium which may be obscured by specular reflection from the point of view of one of the imagers 1 or 2 will not be obscured as seen from the position of the other imager 2 or 1, so that the target will still be readable. Of course, the reader's capability to read any target is increased by its ability to see the target with more than one imager, even in situations where specular reflection is not an issue.

In operation, in the preferred embodiment, the imagers will not be capturing images all at the same time. For example, imager 1 might capture an image first, followed by imager 2, imager 3, etc. Each imager will need an exposure time that is less than about 0.5 milliseconds, and each imager can capture a new image every 16.67 ms or so. Hence, if each imager captures an image approximately every 2.7 ms, all the imagers will capture an image about every 16.6 ms with no two imagers operating at the same time. The illumination LEDs 32 associated with each imager will only be energized during that imager's exposure time. This eliminates the possibility of uneven illumination that could occur if more than one set of illumination LEDs was energized at the same time. It also minimizes the peak current consumption of the entire workstation, by eliminating the need to energize more than one set of illumination LEDs at the same time. Of course, it would also be possible to energize more than one imager at a time, as long as the light from any one imager did not interfere with the other imagers.

In the preferred embodiment, imagers 1, 2, 4 and 5 and their associated optics are all identical. They are focused at the same distance and use the same non-rotationally symmetrical optics to modify the aspect ratio of their respective field of view. Imagers 3 and 6 are identical to each other also. Hence, only two different imager designs are preferred, thereby minimizing manufacturing cost.

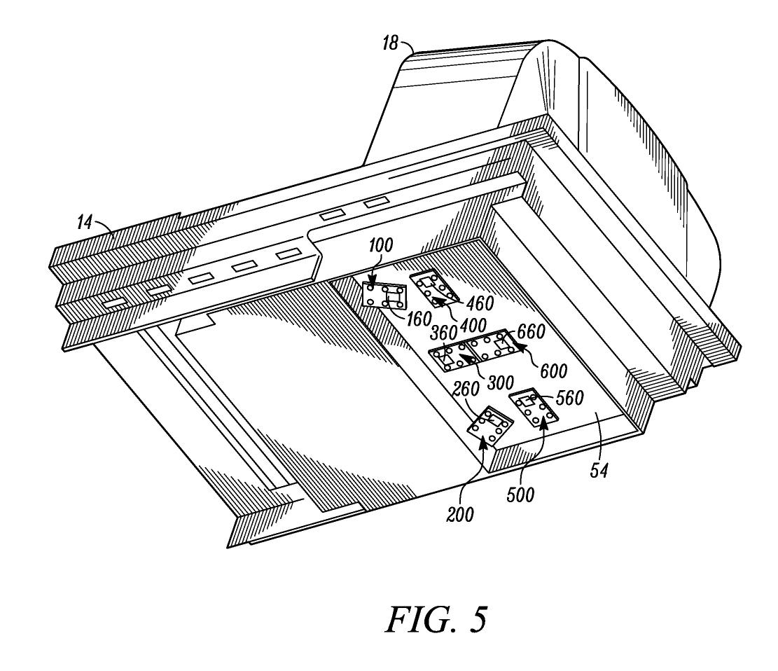

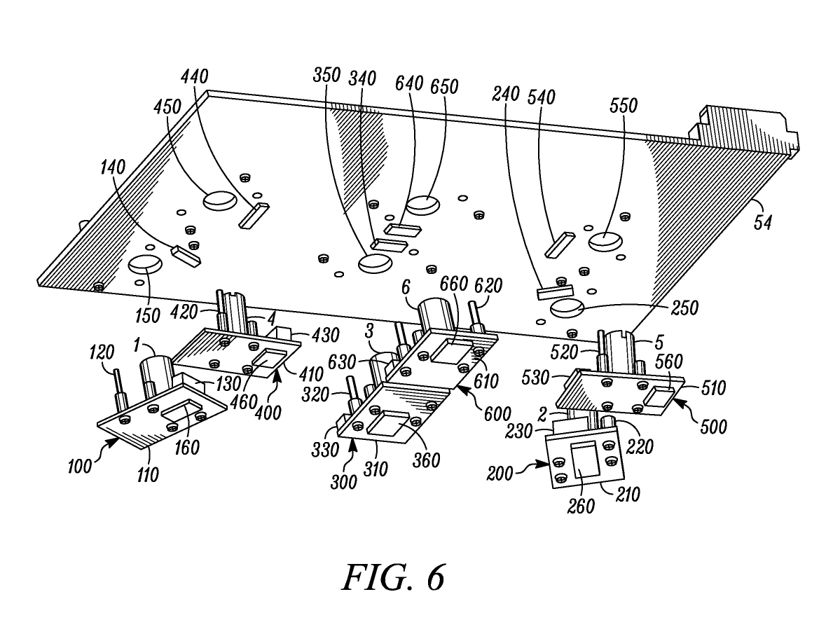

As described so far, the imagers 1, 2, 3, 4, 5 and 6, the illumination LEDs 32 and the single master controller 44 are commonly directly mounted on the motherboard 54. However, in accordance with one aspect of this invention, as depicted in FIGS. 5-6, a plurality of imaging modules 100, 200, 300, 400, 500 and 600 are individually mounted on, and removable from, the motherboard 54. Each imaging module 100, 200, 300, 400, 500 and 600 includes a respective one of the aforementioned plurality of solid-state imagers 1, 2, 3, 4, 5 and 6 and a corresponding respective one of a plurality of local microprocessors or controllers 160, 260, 360, 460, 560 and 660. Each imaging module further includes a respective one of a plurality of individual printed circuit daughterboards 110, 210, 310, 410, 510 and 610 on which the corresponding local microprocessors and the imagers are both commonly mounted.

The local microprocessors 160, 260, 360, 460, 560 and 660 are located externally of the imagers 1, 2, 3, 4, 5 and 6 and are to be contrasted with any internal integrated circuit chips that may be incorporated within the imagers 1, 2, 3, 4, 5 and 6. Such internal chips serve to assist the imager in performing such functions as autofocus, image compression, color, and filtering. By contrast, each external local microprocessor 160, 260, 360, 460, 560 and 660 described herein not only controls its corresponding imager, but also stores image data corresponding to the return light captured by the respective imager in a respective local memory accessible by the external local microprocessor, and also interrogates the stored image data, e.g., decodes the stored image data when the target is a symbol. Each local memory can be internal to its respective local microprocessor and/or may be configured externally of its respective local microprocessor.

The use of a plurality of external local controllers 160, 260, 360, 460, 560 and 660, rather than a single master controller 44 as taught by the prior art, enables each external local controller 160, 260, 360, 460, 560 and 660 to be less costly, less powerful, and less robust than the single master controller 44 of the prior art, without sacrificing fast processing speed and quick workstation performance.

This individual installation of each module at, and individual removal of each module from, the motherboard 54 ensures, among other things, that the above-described entire motherboard assembly need not have to be replaced if only one of the imagers 1, 2, 3, 4, 5 and 6 or if only one of the external local controllers 160, 260, 360, 460, 560 and 660 malfunctions or fails. Preferably, each module 100, 200, 300, 400, 500 and 600 includes a plug-in module connector 130, 230, 330, 430, 530 and 630 mounted on the individual daughterboards 110, 210, 310, 410, 510 and 610. Each module connector 130, 230, 330, 430, 530 and 630 connects to a respective plug-in board connector 140, 240, 340, 440, 540 and 640 mounted on the motherboard 54. Each module has a threaded fastener 120, 220, 320, 420, 520 and 620 for threadedly fastening the respective module to the motherboard 54. The focusing lens of each imager 1, 2, 3, 4, 5 and 6 is held in a cylindrical barrel which passes through alignment mounting holes 150, 250, 350, 450, 550 and 650 extending through the motherboard 54. An indicator lamp can be placed on each module to visually indicate which module on the motherboard 54 needs replacing, after removal of a protective cover from the housing. The cover has been removed from FIG. 5 to show the interior of the workstation from below. The illuminators 32 may also be commonly mounted on the daughterboards in which case, the external local controllers 160, 260, 360, 460, 560 and 660 also serve to control energization of the illuminators 32. In some applications, it may be desirable to mount the illuminators 32 on the motherboard 54.

As described so far, six imaging modules 100, 200, 300, 400, 500 and 600 are preferably used in the bi-optical workstation to capture images from six sides of a target. Six-sided reading is most commonly used in supermarkets. Department stores and mass merchandisers, however, often do not need a six-sided image capture capability. A less expensive imaging bi-optical reader can be created for department stores and mass merchandisers by eliminating one of more imagers. This is easily accomplished by removing one or more of the modules 100, 200, 300, 400, 500 and 600 from the motherboard 54.

In addition, the modular nature of the modules enables individual modules to have different resolutions. For example, one or more modules at one or more locations on the motherboard 54 may have imagers configured with a mega-pixel (MP) resolution, while others of the modules may have imagers configured with a VGA or wide VGA (WVGA) resolution. The local controllers 160, 260, 360, 460, 560 and 660 and their associated local memories can be customized for each imager. A reader can thus be configured with a high performance (all MP resolution), or a lower performance (all VGA resolution), or be configured with mixed different resolutions at different locations. Such upgrades or downgrades can be performed at manufacture or in the field.

Any servicing or maintenance will therefore simply require removal of a gasketed access panel or cover from the bottom of the workstation, thereby enabling access to the modules. Preferably, the motherboard 54 on which the modules are mounted is located no more than 100 millimeters below the generally horizontal plane.

Each local controller 160, 260, 360, 460, 560 and 660 is advantageously less powerful than the master controller 44, and each local controller is preferably separately provided with its own local memory and is operative for processing the captured image from its associated imager and for sending processed and decoded data to a host. A separate master controller may be provided on the motherboard 54 for controlling each local controller. Alternately, any one of the local controllers can serve as the master controller for sending output data to the host. The local controllers can boot off a common, shared, non-volatile memory that stores operational software. The separate master controller can arbitrate and sequence the local controllers to eliminate bus contention. If a separate master controller is not used, then the local controllers can sequentially boot in a daisy chain process.

In accordance with another feature of this invention, a method of imaging a target is performed by supporting a motherboard on a housing, individually mounting a plurality of imaging modules for individual installation on, and individual removal from, the motherboard, and configuring each module with a solid-state imager having an array of light-sensitive sensors for capturing return light from the target over a field of view; a local controller externally of the imager for controlling the imager, for storing image data corresponding to the captured return light, and for interrogating the stored image data; and a daughterboard on which the imager and the local controller are both commonly mounted.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A workstation for imaging a target, comprising:
a housing;
a motherboard supported by the housing; and
a plurality of imaging modules individually mounted for individual installation on, and individual removal from, the motherboard, each module including a solid-state imager having an array of light-sensitive sensors for capturing return light from the target over a field of view, a local controller externally of the imager for controlling the imager, for storing image data corresponding to the captured return light, and for interrogating the stored image data, and a daughterboard on which the imager and the local controller are both commonly mounted.

2. The workstation of claim 1, wherein the housing has one window located in a generally horizontal plane, and another window located in a generally upright plane that intersects the generally horizontal plane, and wherein the imagers capture the return light from the target through at least one of the windows.

3. The workstation of claim 1, and an illumination assembly supported by each daughterboard, for illuminating the target with illumination light during an exposure time period, and wherein each local controller controls the respective imager and the respective illumination assembly to capture the illumination light during a respective exposure time period.

4. The workstation of claim 1, wherein each local controller controls the respective imager to produce electrical signals indicative of the target being imaged, for processing the electrical signals to read the target, and for outputting the processed electrical signals.

5. The workstation of claim 1, wherein the housing has one window located in a generally horizontal plane, and another window located in a generally upright plane that intersects the generally horizontal plane, and wherein a first sub-plurality of the imaging modules captures the return light from the target through one of the windows, and wherein a second sub-plurality of the imaging modules captures the return light from the target through another of the windows, and wherein each sub-plurality of the imaging modules captures the return light from the target over different fields of view that intersect one another.

6. The workstation of claim 1, wherein each module includes a plug-in module connector mounted on each daughterboard, and a plurality of plug-in motherboard connectors mounted on the motherboard for connection with each module connector.

7. The workstation of claim 1, wherein the modules are interchangeably mounted on the motherboard.

8. The workstation of claim 1, wherein each module has a fastener for fastening the respective module to the motherboard.

9. The workstation of claim 1, and a master controller on the motherboard, for controlling each local controller.

10. The workstation of claim 1, and a local diagnostic indicator on each module, for indicating the status of the respective module.

11. A method of imaging a target, comprising:
supporting a motherboard by a housing;
individually mounting a plurality of imaging modules for individual installation on, and individual removal from, the motherboard; and
configuring each module with a solid-state imager having an array of light-sensitive sensors for capturing return light from the target over a field of view, a local controller externally of the imager for controlling the imager, for storing image data corresponding to the captured return light, and for interrogating the stored image data, and a daughterboard on which the imager and the local controller are both commonly mounted.

12. The method of claim 11, and configuring the housing with one window located in a generally horizontal plane, and with another window located in a generally upright plane that intersects the generally horizontal plane, and wherein the capturing is performed by having the imagers capture the return light from the target through at least one of the windows.

13. The method of claim 11, and illuminating the target with illumination light from an illumination light source for each imager during an exposure time period, and wherein the controlling is performed by having each local controller control the respective imager and the respective illumination light source to capture the illumination light during a respective exposure time period.

14. The method of claim 11, wherein the controlling is performed by having each local controller control the respective imager to produce electrical signals indicative of the target being imaged, by processing the electrical signals to read the target, and by outputting the processed electrical signals.

15. The method of claim 11, and configuring the housing with one window located in a generally horizontal plane, and with another window located in a generally upright plane that intersects the generally horizontal plane, and wherein the capturing is performed by capturing the return light from the target through one of the windows by a first sub-plurality of the imaging modules, and by capturing the return light from the target through another of the windows by a second sub-plurality of the imaging modules, and wherein each sub-plurality of the imaging modules captures the return light from the target over different fields of view that intersect one another.

16. The method of claim 11, and mounting a plug-in module connector on each daughterboard, and mounting a plurality of plug-in motherboard connectors on the motherboard for connection with each module connector.

17. The method of claim 11, and interchangeably mounting the modules on the motherboard.

18. The method of claim 11, and fastening each module to the motherboard.

19. The method of claim 11, and controlling each local controller with a master controller on the motherboard.

20. The method of claim 11, and indicating the status of the respective module.
